(19) United States
(12) Patent Application Publication
(10) Pub. No.: US 2007/0055829 A1
(43) Pub. Date: Mar. 8, 2007

(54) Internal software security analysis in non-volatile memory

(76) Inventor: John Rudelic, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/206,571

(22) Filed: Aug. 17, 2005

(51) Int. Cl. G06F 13/28

(52) U.S. Cl. 711/149

(57) ABSTRACT

A non-volatile memory device may contain code in protected storage that is executed to examine software that is intended to be executed from a memory array of the non-volatile memory device. The code may look for instructions, patterns, sequences, etc., in the software that indicate whether the software, when executed, might perform unauthorized functionality. The software may be examined after being written into the memory array, or in some embodiments may be examined in a buffer before being written into the memory array. In some embodiments, the code, array, buffer (if applicable), and control circuitry for those elements may be contained within a single integrated circuit.

### BACKGROUND

Software in non-volatile memory is subject to various types of undesired modification, sometimes by unauthorized parties with hostile intent. Since that software may sometimes be upgraded or replaced with other software in the limited address space of the on-volatile memory, the opportunities for such undesired modification may be numerous. Various techniques have been developed to examine the software, either before or after writing it to the non-volatile memory, to verify that it does not represent a harmful attach on the system. However, this examination is generally performed by software that is located in main memory, and which is therefore vulnerable to undesired modification itself.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a block diagram of a memory device with a buffer, according to an embodiment of the invention.

FIG. 2 shows a flow diagram of a method of operating the memory device of FIG. 1, according to an embodiment of the invention.

FIG. 3 shows a block diagram of a memory device without the buffer of FIG. 1, according to an embodiment of the invention.

FIG. 4 shows a flow diagram of a method of operating the device of FIG. 3, according to an embodiment of the invention.

FIG. 5 shows a system comprising a non-volatile memory device, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include, but is not limited to, read only memory (ROM); random access memory (RAM); magnetic disk storage media; optical storage media; flash memory devices. A machine-readable medium may also include a tangible medium through which electrical, optical, acoustical or other form of propagated signals representing the instructions may pass, such as antennas, optical fibers, communications interfaces, and others.

Various embodiments of the invention may make use of security scanning code located in protected areas of hardware that are relatively invulnerable to unauthorized modification. This security scanning code may be used to examine software that is designated for execution in a non-volatile memory, either before or after the software is written into the memory array of that non-volatile memory. The results of this examination may be used to alert the system whenever software is discovered that may be potentially harmful to the system.

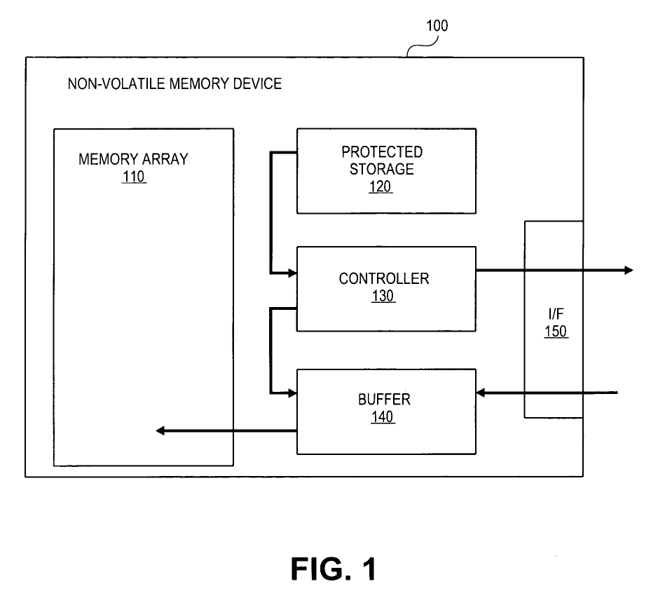

FIG. 1 shows a block diagram of a memory device with a buffer, according to an embodiment of the invention. In some embodiments, all the elements of memory device 100 may be contained within a single integrated circuit, although other embodiments may differ. The illustrated embodiment of FIG. 1 shows a memory device 100 comprising a non-volatile memory array 110, protected storage 120, controller 130, buffer 140, and an interface 150. Although device 100 is frequently described herein as a flash memory device for convenient reference, other embodiments of device 100 may use any feasible non-volatile memory technology other than flash. Memory array 110 may be used to contain code to be executed, and may also contain data to be acted upon by the code. In some embodiments the memory array may be segmented into separate code and data sections, which may facilitate efficient examination of the code. The memory array may be of any feasible size, such as but not limited to 16 kilobytes (KB), 1 megabyte (MB), 16 MB, 512 MB, etc.

Protected storage 120 may contain code (which may sometimes be referred to herein as ‘scanning code’), which when executed, examines software to be executed in flash array 110 to make sure the software does not contain any unauthorized functionality. The software that is supposed to execute in flash array 110 is intended to perform certain functions in certain ways. The software is also intended to not perform certain functions that might be harmful to the intended purpose of the system. The purpose of examination by the scanning code may be to detect if this software contains code that will perform functions other than those intended and/or will perform functions that might be harmful to the intended purpose of the system. The scanning code may operate in any feasible manner, such as but not limited to one or more of: 1) looking for certain instructions, 2) looking for certain sequences of instructions, 3) looking for instructions that access unauthorized areas, 4) looking for patterns of instructions and/or data, 5) etc. In some embodiments the scanning code may be permanently programmed into the protected storage in a manner that makes it unmodifiable by a host processor or any other device external to the memory device 100. Such unmodifiable protected storage may be, but is not limited to, read-only memory (ROM). Some embodiments may also make the protected storage unreadable by a host processor or other device external to memory device 100. Other embodiments may use other techniques, such as allowing the scanning code to be modifiable under certain restricted conditions. Although the protected storage is generally described herein as a separate item from, and external to, the flash array, in some embodiments the protected storage may be a protected area within the flash array. Such embodiments may protect the protected area in any feasible manner, such as but not limited to: 1) locking the protected area, 2) authenticating the contents of the protected area before executing the scanning code, 3) hiding the existence of the protected area from the hardware and/or instructions that provide the software to be scanned, 4) etc.

Interface (I/F) 150 may allow the memory device 100 to communicate with other devices such as but not limited to: 1) one or more processors, 2) a higher-level memory controller, 3) other devices coupled to I/F 150 over a bus, 4) etc. In some embodiments I/F 150 may comprise one or more of: 1) a status register to indicate a result of the examination, 2) an interrupt generation circuit to notify a host processor or other device of a result of the examination, 3) a bus interface, 4) control lines, 5) etc. Interface 150 may be used for various functions, such as but not limited to: 1) transferring software from an external device into buffer 140, from where the software may be examined, 2) transferring commands from an external device into controller 130, from where the commands may control operation of flash memory device 100, 3) providing status and/or other information from flash memory device 100 to an external device, 4) etc.

Buffer 140 may be used to temporarily store software, or portions of software, to be written into flash array 110 for execution. In some embodiments buffer 140 may comprise volatile memory, but other embodiments may differ. The software in buffer 140 may be examined by executing the scanning code while the software resides in buffer 140. Depending on the size of buffer 140 and the size of the software to be examined, at any given time the buffer may hold all or only a portion of the software to be examined. Once the software, or a portion of the software, has been examined and found to be acceptable, it may be copied into flash array 110, and additional software may be written into buffer 140 and examined there. When all the necessary software has been validated by the scanning code and copied into flash array 110, that software may be executed in the flash array 110. In the event that the scanning code detects unauthorized functionality in the software contained in the buffer, flash memory device 100 may notify an external device, such as a processor, of that fact. The processor may then determine what to do about the problem. In some embodiments, such notification may be in the form of an interrupt and/or status bits on one or more control or data lines, but other embodiments may use other techniques. If there is software already in memory array 110 that is related to the software in the buffer with unauthorized functionality, the software in memory array 110 may be erased or otherwise disabled.

In some embodiments, the software to be placed in flash array 110 may be segmented into an instruction portion and a data portion, and the scanning code may examine only the instruction portion. In some of the embodiments with this segmentation, only the instruction portion may be placed in buffer 140 for examination, while the data may be written directly to flash array 110 without being placed in the buffer first. In other embodiments with this segmentation, the instruction and data portions may be placed in different portions of buffer 140 to facilitate ease of examination. In still other embodiments both the instructions and the data may be examined by the scanning code.

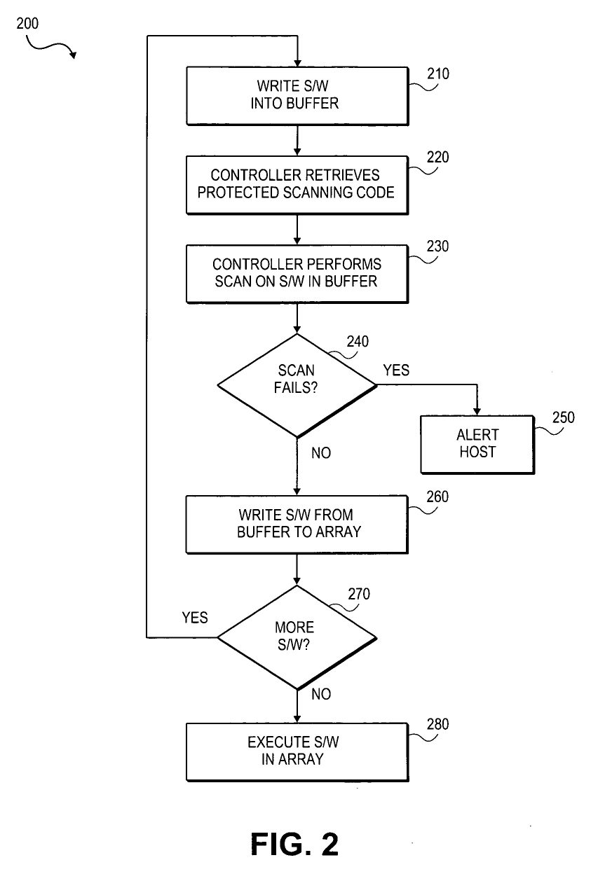

FIG. 2 shows a flow diagram of a method of operating the device of FIG. 1, according to an embodiment of the invention. At 210 of flow diagram 200, software may be written from an external device into a buffer in a non-volatile memory device. At 220, scanning code may be retrieved from a protected area and at 230 the scanning code may be executed to perform an examination of the software in the buffer. In some embodiments the combination of ‘retreiving’ and ‘executing’ code may be done one instruction at a time, but in other embodiments a block of code may be retrieved and then executed. (Note: here and elsewhere in the document, the term ‘software’ is used to denote the instructions that are examined to determine if they represent unauthorized functionality, while either of the terms ‘code’ or ‘scanning code’ is used to denote the instructions that are executed to perform that examination. These terms are used in this manner to avoid confusion between the instructions that perform the examination and the instructions that are to be examined. The use of these terms does not imply that data may or may not also be included with the respective sets of instructions.)

If the scanning examination fails (i.e., if unauthorized functionality is located in the software), a host processor may be alerted at 250. The host processor may then take any feasible remedial action, such as but not limited to issuing commands to erase or otherwise disable the offending software so that it cannot be executed. However, if the software passes the scanning test, the software may then be written into a flash memory array at 260. If there is more software to be examined, as determined at 270, operations 210-260 may be repeated until the remaining software has been examined and written into the memory array. When there is no more software to examine, the software in the memory array may be executed at 280.

In some embodiments the same controller may control moving the software into the buffer, retrieving the scanning code, executing the scanning code, alerting the host processor if the scan fails, and moving software that passed the scanning test into the array. In other embodiments, control of these various operations may be distributed among multiple controllers in any feasible manner.

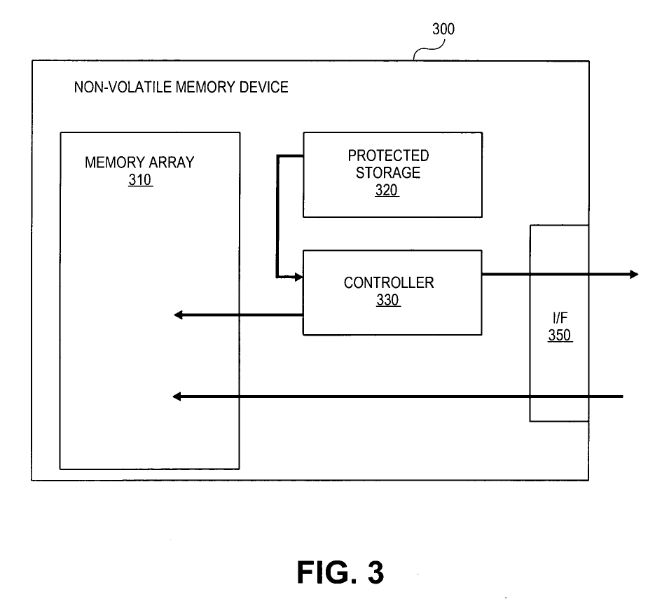

FIG. 3 shows a block diagram of a memory device without the buffer of FIG. 1, according to an embodiment of the invention. In some embodiments, all the elements of memory device 300 may be contained within a single integrated circuit, although other embodiments may differ. Memory device 300 may comprise a non-volatile memory array 310, protected storage 320, controller 330, and interface 350, which may be similar to their counterparts 110, 120, 130, and 150 respectively in FIG. 1. In many ways flash memory device 300 of FIG. 3 may operate in a similar manner to flash memory device 100 of FIG. 1, except the device of FIG. 3 does not have a temporary storage buffer to hold the software while it is being examined. Instead, the software may be examined by the code of protected storage 320 after the software has been written into the memory array 310.

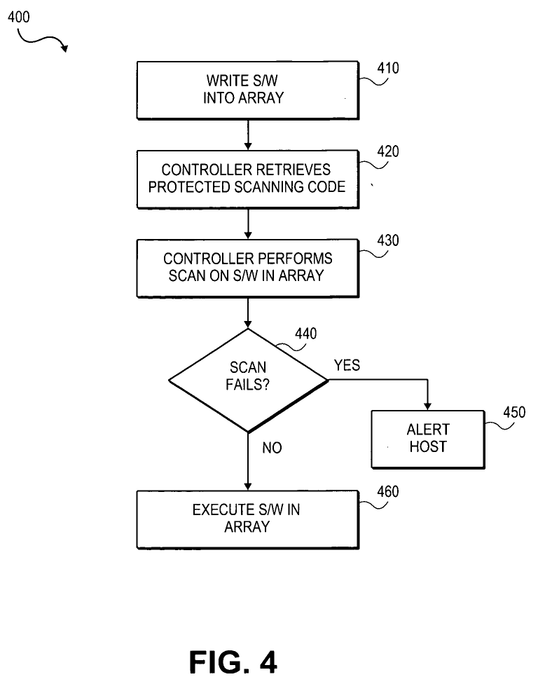

FIG. 4 shows a flow diagram of a method of operating the device of FIG. 3, according to an embodiment of the invention. At 410 of flow diagram 400, software may be written into a memory array from an external device. At 420, scanning code may be retrieved from a protected area and at 430 the scanning code may be executed to perform an examination of the software in the array. If the scanning examination fails (i.e., if unauthorized functionality is located in the software), a host processor may be alerted at 450. The host processor may then take any feasible remedial action, such as but not limited to issuing commands to erase or otherwise disable the offending software so that it cannot be executed. However, if the software passes the scanning test, the software in the memory array may be executed at 480.

In some embodiments the same controller may control moving the software into the array, retrieving the scanning code, executing the scanning code, and alerting the host processor if the scan fails. In other embodiments, control of these various operations may be distributed among multiple controllers in any feasible manner.

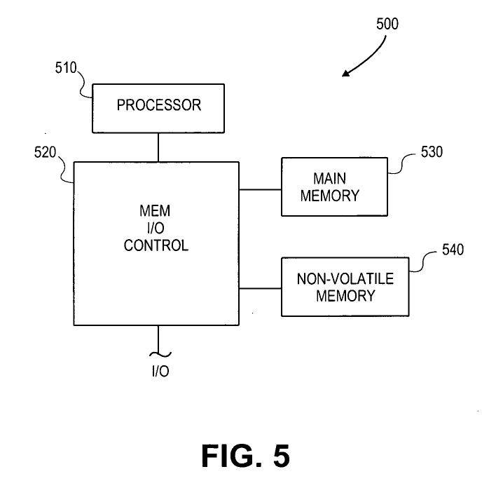

FIG. 5 shows a system comprising a non-volatile memory device, according to an embodiment of the invention. The illustrated system 500 may comprise one or more processors 510, control circuitry 520 to control various input-output operations for memory and other devices, a main memory 530, and a non-volatile memory 540. Non-volatile memory 540 may comprise various types of non-volatile memory, such as but not limited to flash memory, polymer memory, 3) ferro-magnetic memory, or other types of non-volatile memory. Non-volatile memory 540 may be as previously described for FIGS. 1-4. Main memory 530 may comprise any type of memory suitable for holding instructions and data for processor 510, such as but not limited to static random access memory (SRAM), dynamic random access memory (DRAM), etc., and/or may comprise non-volatile memory that is identical to, similar to, or different than non-volatile memory 540.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a memory device comprising:
a non-volatile memory array;
protected storage to contain code;
a controller to execute the code to examine software to determine if the software contains unauthorized functionality; and
an interface to notify a host processor if the software contains the unauthorized functionality.

2. The apparatus of claim 1, further comprising a buffer;
wherein the controller is to examine the software in the buffer and to transfer the software to the memory array if the software does not contain unauthorized functionality.

3. The apparatus of claim 1, wherein the notification interface comprises at least one of:
an interrupt circuit;
a status register to indicate a result of the examination; and
a bus interface to transmit a result of the examination.

4. The apparatus of claim 1, wherein the non-volatile memory array is a flash memory array.

5. The apparatus of claim 1, wherein the code is not modifiable by a host processor coupled to the memory device.

6. The apparatus of claim 1, wherein the code is not readable by a host processor coupled to the memory device.

7. The apparatus of claim 1, wherein:
the software is segmented into an instruction portion and a data portion; and
the controller is to execute the code to examine only contents of the instruction portion.

8. The apparatus of claim 1, wherein the array, the protected storage, the controller and the interface are contained within a single integrated circuit.

9. The apparatus of claim 1, further comprising a main memory coupled to the memory device.

10. The apparatus of claim 9, wherein the main memory comprises dynamic random access memory.

11. The apparatus of claim 1, wherein the protected storage is a protected area within the non-volatile memory array.

12. The apparatus of claim 1, wherein the protected storage is external to the non-volatile memory array.

13. A method, comprising:
accessing scanning code from protected storage;
executing the scanning code to examine a block of software;
determining, from said executing the scanning code, if the software contains unauthorized functionality; and
executing the software if the software does not contain the unauthorized functionality.

14. The method of claim 13, further comprising:
transferring the software from a buffer to a memory array;
wherein said executing the scanning code comprises examining the block of software in the buffer prior to said transferring, and
wherein said executing the software comprises executing the software from the memory array subsequent to said transferring.

15. The method of claim 13, wherein:
said executing the scanning code comprises examining the block of software in a memory array; and
said executing the software comprises executing the software from the memory array.

16. The method of claim 13, further comprising notifying a host processor if the software contains the unauthorized functionality;

17. An article comprising
a machine-readable medium that provides instructions, which when executed by a computing platform, result in at least one machine performing operations comprising:
retrieving scanning code from a protected storage; and
executing the scanning code to examine, within a same device that contains the protected storage, software unauthorized functionality.

18. The article of claim 17, wherein the operations further comprise notifying a host processor if the software is determined to contain the unauthorized functionality.

19. The article of claim 17, wherein said executing within a same device comprises executing within a same integrated circuit that contains the protected storage.
